(19) United States
(12) Patent Application Publication
(10) Pub. No.: US 2026/0056302 A1
(43) Pub. Date: Feb. 26, 2026

(54) CALIBRATION METHOD, DEVICE, AND SYSTEM FOR LIDAR CHANNEL ANGLE ERROR

(71) Applicant: AUTOX TECH PTE. LTD., SINGAPORE (SG)

(72) Inventors: Jianxiong Xiao, Shenzhen (CN); Yizhou Shan, Shenzhen (CN); Zhuo Li, Shenzhen (CN)

(73) Assignee: AUTOX TECH PTE. LTD., SINGAPORE (SG)

(21) Appl. No.: 19/214,227

(22) Filed: May 21, 2025

(30) Foreign Application Priority Data
Sep. 24, 2024 (CN) 2024113420974

(51) Int. Cl. G01S 7/497; G01S 7/481; G01S 17/89

(52) U.S. Cl. CPC G01S 7/4972; G01S 7/4817; G01S 17/89

(57) ABSTRACT

A calibration method for LiDAR channel angular error is applied to a calibration device with a controller and a moving component. The LiDAR optical engine on the moving component is controlled by the controller to deflect. The method includes: aligning the LiDAR's detection center with the calibration-target center; selecting channels to be calibrated; controlling the selected channels to project onto the target based on their positional relationship; acquiring an image of the target to get real and reference spots; determining vertical and horizontal offset angles according to the spot positions; and calibrating the channels using these offset angles.

### CROSS REFERENCE TO RELATED APPLICATION

This non-provisional patent application claims priority under 35 U.S.C. §119 from Chinese Patent Application No.2024113420974 filed on Sep. 24, 2024, the entire content of which is incorporated herein by reference.

### TECHNICAL FIELD

The disclosure relates to LiDAR technologies, particularly to a calibration method, a calibration device, and a calibration system for LiDAR channel angle error.

### BACKGROUND

LiDAR acquires information about a calibration target by emitting laser pulses towards the calibration target and receiving the reflected pulses, presenting the acquired information in the form of point clouds. Each point in the point cloud corresponds to a channel of the LiDAR, and the channels of the LiDAR are arranged according to pre-designed positions. However, due to errors in the manufacturing process and production techniques, after actual production is completed, there may be deviations between the actual positions of the LiDAR channels and their pre-designed positions. Consequently, the obtained LiDAR point cloud results may deviate from the true LiDAR point cloud results, leading to deviations in the detection or measurement results of the LiDAR.

### SUMMARY

In view of this, the disclosure provides a calibration method, controller, calibration device, and system for LiDAR channel angle error, which can achieve calibration of LiDAR to enable it to have better accuracy.

In the first aspect, the disclosure provides a calibration method for LiDAR channel angle error. The calibration method for LiDAR channel angular error, being applied to a calibration device to calibrate channels of a LiDAR optical engine; wherein the calibration device faces a calibration target, and comprises a controller, and a moving component, the LiDAR optical engine is installed on the moving component, the LiDAR optical engine and the moving component are electrically connected to the controller, the controller is configured to control the moving component to deflect in a vertical direction and/or in a horizontal direction to drive the LiDAR optical engine to deflect relative to the calibration target, and the calibration method for LiDAR channel angular error includes: controlling the moving component to move in order to make a detection center of the LiDAR optical engine align with a center of the calibration target; selecting one or more channels to be calibrated; according to a positional relationship between the LiDAR optical engine and the calibration target, controlling the channels to be calibrated to project onto the calibration target in a predetermined direction to obtain one or more corresponding spot centers, wherein the positional relationship includes that each channel to be calibrated is aligned with the center of the calibration target, or the detection center of the LiDAR optical engine is aligned the center of the calibration target; acquiring an image of the calibration target to obtain real spots and reference spots of the channels to be calibrated, wherein the real spots are spots projected by the channels to be calibrated onto the calibration target, and the reference spots are predetermined in the calibration target, when the positional relationship is that each channel to be calibrated is aligned with the center of the calibration target, the reference spots correspond to the center of the calibration target; when the detection center of the LiDAR optical engine is aligned with the center of the calibration target, the reference spots correspond to centers of the channels to be calibrated, and the image is acquired by an image acquisition device; determining vertical offset angles and horizontal offset angles of the channels to be calibrated according to a positional relationship between the real spots and the reference spots of the channels to be calibrated obtained; calibrating the channels to be calibrated according to the vertical offset angles and the horizontal offset angles of the channels to be calibrated.

In the third aspect, the disclosure provides a calibration device for LiDAR channel angle error. The calibration device is configured to calibrate each channel of a LiDAR optical engine and face opposite to a calibration target. The calibration device includes a moving component, and a controller. The moving component is configured to drive the LiDAR optical engine to deflect relative to the calibration target in the vertical direction and/or in the horizontal direction. The controller includes a memory and a processor. The memory is configured to store computer programs. The processor configured to execute the computer programs to implement the calibration method for LiDAR channel angle error.

In the third aspect, the disclosure provides a calibration system for LiDAR channel angle error, includes the calibration device, a calibration target, and an image acquisition device.

The above calibration method, controller, calibration device, and system for LiDAR channel angle error obtain the vertical offset angle and horizontal offset angle of each channel relative to its desired installation angle, and then calibrate each channel of the LiDAR optical engine based on these offset angles, enabling the LiDAR optical engine to have better detection accuracy.

### BRIEF DESCRIPTION OF THE DRAWINGS

To more clearly illustrate the technical solutions in the embodiments of the disclosure or in the prior art, the following provides a brief introduction to the drawings required for describing the embodiments or the prior art. It is apparent that the drawings described below are merely some embodiments of the disclosure. For those skilled in the art, other drawings can be obtained based on the structures shown in these drawings without exercising inventive effort.

FIG. 1 is a flowchart of a calibration method for LiDAR channel angle errors in accordance with a first embodiment.

FIG. 2 is a sub-flowchart of a calibration method for LiDAR channel angle errors in accordance with a first embodiment.

FIG. 3 is a sub-flowchart of a calibration method for LiDAR channel angle errors in accordance with a first embodiment.

FIG. 4 is a schematic diagram of electrical connections of a calibration device for LiDAR channel angle errors in accordance with a first embodiment.

FIG. 5 is a schematic diagram of the structure of a calibration system for LiDAR channel angle errors in accordance with a first embodiment.

FIG. 6 is a calibration target image in accordance with a first embodiment.

FIG. 7 is a calibration target image in accordance with a second embodiment.

The achievement of the objectives, functional characteristics, and advantages of the disclosure will be further explained with reference to the embodiments and drawings.

### DETAILED DESCRIPTION OF THE EMBODIMENTS

In order to make the purpose, technical solution, and advantages of this application clearer and clearer, the following will provide further detailed explanations of this application in conjunction with the accompanying drawings and embodiments. It should be understood that the specific embodiments described here are only intended to explain the present application and are not intended to limit the present application. Based on the embodiments in this application, all other embodiments obtained by ordinary technical personnel in this field without creative labor fall within the scope of protection of this application.

The terms “first,” “second,” “third,” “fourth,” etc. (if present) in the specification, claims, and accompanying drawings of the present application are used to distinguish similar planning objects and are not necessarily used to describe a specific sequence or order. It should be understood that such terms, when used, may be interchangeable under appropriate circumstances. In other words, the described embodiments may be implemented in an order other than that illustrated or described herein. Furthermore, the terms “include” and “have” and any variations thereof may also encompass additional content. For example, a process, method, system, product, or device comprising a series of steps or units is not limited to only those steps or units clearly listed but may include other steps or units not clearly listed or inherent to those processes, methods, products, or device.

It is important to note that the descriptions involving “first,” “second,” etc., in the present application are solely for descriptive purposes and should not be understood as indicating or implying their relative importance or implicitly specifying the number of indicated technical features. Therefore, features qualified by “first,” “second,” etc., may explicitly or implicitly include one or more of such features. In addition, the technical solutions among the various embodiments may be combined with each other, but this must be based on the ability of ordinary skilled artisans in the field to achieve such combinations. When the combination of technical solutions contradicts each other or cannot be implemented, such combinations should be deemed non-existent and not within the scope of protection claimed in the present application.

A LiDAR optical engine includes multiple channels, each arranged at a desired installation angle. Different channels correspond to different desired installation angles. Due to errors in manufacturing processes and production techniques, after actual production is completed, the actual installation angle of each channel may have a certain deviation from the desired installation angle, resulting in deviations between the obtained LiDAR point cloud results and the actual LiDAR point cloud results. To better restore the actual LiDAR point cloud results, the disclosure provides a calibration method for LiDAR channel angle errors, which calibrates each channel of the LiDAR through this calibration method.

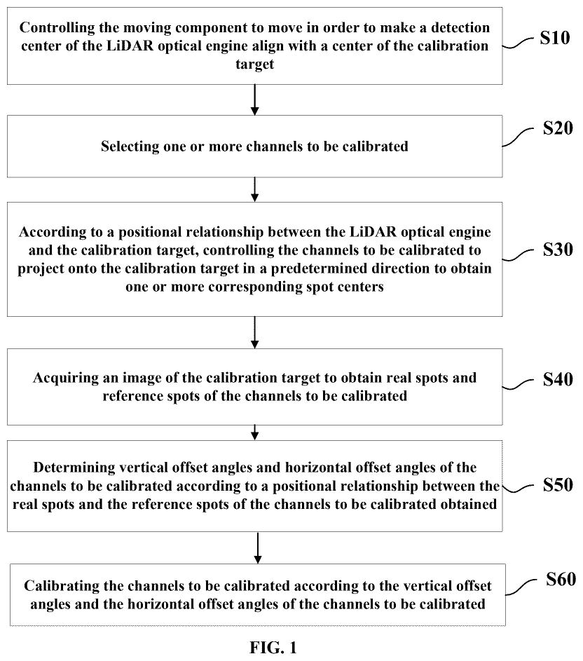

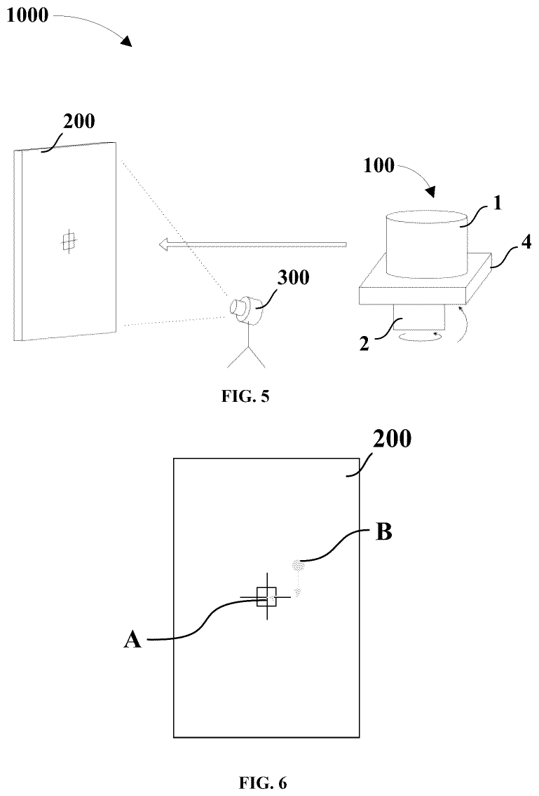

Referring to FIGS. 1 and 4-5, FIG. 1 is a flowchart of the calibration method for LiDAR channel angle errors. FIG. 4 is a schematic diagram of the electrical connections of the calibration device for LiDAR channel angle errors. FIG. 5 is a schematic diagram of the structure of the calibration system for LiDAR channel angle errors. The calibration method for LiDAR channel angle errors provided by the disclosure is applied to a calibration device 100, which faces a calibration target 200. The calibration device 100 is configured to calibrate each channel of a LiDAR optical engine 1. The calibration device 100 includes a controller 3, and a moving component 2. The LiDAR optical engine 1 is installed on the moving component 2, and both the LiDAR optical engine 1 and the moving component 2 are electrically connected to the controller 3. The controller 3 is configured to control the moving component 2 to deflect in the vertical direction and/or the horizontal direction to drive the LiDAR optical engine 1 to deflect relative to the calibration target 200. The calibration method for LiDAR channel angle errors includes steps S10 to S60.

In Step S10: controlling the moving component 2 to move in order to make a detection center of the LiDAR optical engine 1 align with the center of the calibration target. Specifically, the controller 3 controls the moving component 2 to move so that the detection center of the LiDAR optical engine 1 is aligned with the center of the calibration target. Here, it should be noted that the detection center is the center of the detection area formed by all channels.

In Step S20: selecting one or more channels to be calibrated. Specifically, the controller 3 controls the LiDAR optical engine 1 to select one or more channels to be calibrated. It is well-known that due to production deviations, there is a certain offset between the actual installation angle and the desired installation angle of each channel. By obtaining the offset between the actual installation angle and the desired installation angle of each channel through a calibration method, each channel can be calibrated, thereby improving the accuracy of the detection results of the LiDAR optical engine 1. As an illustrative example, two calibration methods will be presented for determining the offset between each channel's actual and desired installation angles will be presented.

The first calibration method includes: controlling the deflection of the moving component 2 to successively align each channel to be calibrated with the center of the calibration target, and then deriving the offset between the actual installation angle and the desired installation angle of each channel to be calibrated based on the deflection amount of the moving component 2. The second calibration method involves obtaining a calibration target image including real spots and reference spots corresponding to the actual installation angle and the desired installation angle, and obtaining the offset between the actual installation angle and the desired installation angle through image calculation and analysis. It is understandable that although only one channel can be aligned with the center of the calibration target at the same time, a calibration target image containing spots corresponding to multiple channels can be obtained simultaneously. Therefore, the first calibration method can only operate on one channel, while the second calibration method can operate on multiple channels simultaneously. The specific schemes of the first and second calibration methods will be described through the first and second embodiments below.

In Step S30: according to a positional relationship between the LiDAR optical engine 1 and the calibration target 200, controlling the channels to be calibrated to project onto the calibration target 200 in a predetermined direction to obtain one or more corresponding spot centers. The positional relationship includes that each channel to be calibrated aligned with the center of the calibration target or the detection center of the LiDAR optical engine 1 aligned with the center of the calibration target. In a first embodiment, when the positional relationship is that each channel to be calibrated is aligned with the center of the calibration target, Step S30 specifically includes: the controller 3 controlling the movement of the moving component 2 to enable each channel to be calibrated to be successively aligned with the center of the calibration target, and once a channel is aligned, the controller 3 activates/illuminates the currently aligned channel to be calibrated once. Further, according to the desired installation angle of the channel to be calibrated, the controller 3 moves the moving component 2 such that the channel to be calibrated is aligned with the center [0, 0] of the calibration target. For example, the desired installation angle corresponding to the channel to be calibrate is [θ_{pitch}, θ_{yaw}], which means moving the moving component 2 by [−θ_{pitch}, −θ_{yaw}]. It is understandable that since the desired installation angle only represents the ideal setting for the channel, not the actual installation angle, therefore, when the moving component 2 is moved according to the desired installation angle, the channel to be calibrated is only theoretically aligned with the center [0, 0] of the calibration target. In reality, the spot projected by the channel to be calibrated does not align with the center [0, 0] of the calibration target. For example, assume that the desired installation angle corresponding to the channel to be calibrated is [2, 2], and the actual installation angle of the channel to be calibrated is [3, 3], according to the desired installation angle [2, 2], the moving component 2 is adjusted by an angle of [−2, −2], the channel to be calibrated will align with an angle of [1,1] instead of the center [0, 0] of the calibration target.

In the second embodiment, when the positional relationship is that the detection center of the LiDAR optical engine 1 is aligned with the center of the calibration target, Step S30 specifically includes: the controller 3 successively or simultaneously activates/illuminates one or more channels to be calibrated. It is understandable that compared to the first embodiment, the second embodiment omits the step of controlling the movement of the moving component 2 to align the channels to be calibrated with the center of the calibration target.

In Step S40: acquiring an image of the calibration target 200 to obtain the real spot and the reference spot of the channels to be calibrated. The real spot is the spot projected by the channel to be calibrated onto the calibration target 200, while the reference spot is predetermined within the calibration target 200. When each channel to be calibrated is in a positional relationship where it is aligned with the center of the calibration target,, the reference spot corresponds to the center of the calibration target; when the detection center of the LiDAR optical engine 1 is aligned with the center of the calibration target, the reference spot has a one-to-one correspondence with the center of the channel to be calibrated. The image is captured through an image acquisition device 300. Specifically, the controller 3 controls the image acquisition device 300 to capture the current image of the calibration target 200, and the controller 3 obtains the current image of the calibration target 200 from the image acquisition device 300 and derives the real spot and the reference spot of the current channel to be calibrated based on the current image of the calibration target 200.

Referring to FIG. 6, the calibration target image in accordance with a first embodiment is shown. In the first embodiment, when the positional relationship is such that each channel to be calibrated is aligned with the center of the calibration target, the image of the calibration target is captured to obtain the actual light spot and reference light spot of the channel to be calibrated. At this moment, the position of the reference light spot corresponds to the center of the calibration target. It is understandable that the positional relationship between the actual light spot and the center of the calibration target can be either coinciding or offset.

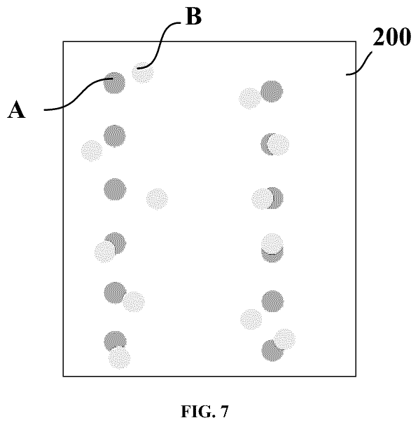

Referring to FIG. 7, the calibration target image in accordance with a second embodiment is shown. In the second embodiment, when the positional relationship is such that the detection center of the LiDAR optical engine 1 is aligned with the center of the calibration target, the controller 3 sequentially controls multiple channels to project onto the calibration target 200 in a predetermined direction to obtain individual calibration target images for each channel. The controller 3 uses software image superimposition to overlays these individual calibration target images, as a result, a superimposed calibration target image of multiple channels as shown in FIG. 7, is obtained. Alternatively, the controller 3 simultaneously controls multiple channels to project onto the calibration target 200 in a predetermined direction to obtain a superimposed calibration target image of multiple channels at once, thereby obtaining the actual light spots and reference light spots of multiple channels through the superimposed calibration target image. It is understandable that the reference light spot at this point corresponds to the light spot associated with the desired installation angle of the channel to be calibrated.

In Step S50: determining the vertical offset angle and horizontal offset angle of the channel to be calibrated based on the positional relationship between the obtained actual light spot and reference light spot of the channel to be calibrated. Specifically, the controller 3 obtains the positional relationship between the actual light spot and reference light spot from the current image of the calibration target 200 and determines the vertical offset angle and horizontal offset angle of the channel to be calibrated based on this positional relationship.

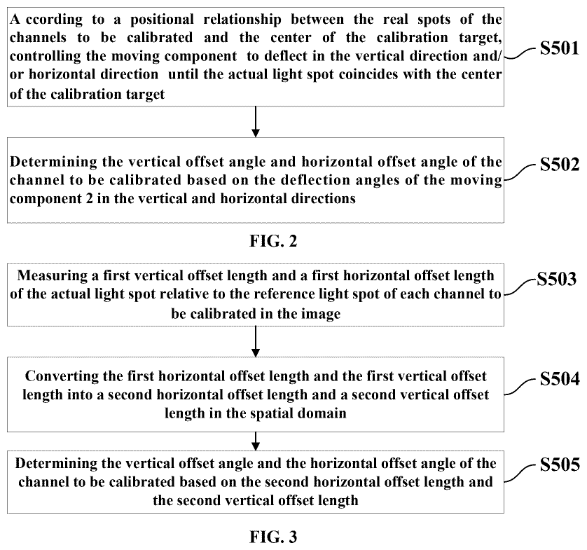

Referring to FIG. 2, a sub-flowchart of the calibration method for LiDAR channel angle error in accordance with a first embodiment is illustrated. In the first embodiment, when the positional relationship is such that each channel to be calibrated is aligned with the center of the calibration target, Step S50 specifically includes Steps S501-S502.

In Step S501: according to a positional relationship between the real spots of the channels to be calibrated and the center of the calibration target, controlling the moving component 2 to deflect in the vertical direction and/or horizontal direction until the actual light spot coincides with the center of the calibration target. Specifically, the controller 3 determines the positional relationship between the actual light spot and the center of the calibration target based on image information. If the positional relationship indicates that the actual light spot is deviated from the center of the calibration target, the controller 3 controls the moving component 2 to deflect in the vertical direction so that the actual light spot and the center of the calibration target are on the same horizontal line. Subsequently, the controller 3 controls the moving component 2 to deflect in the horizontal direction so that the actual light spot fully coincides with the center of the calibration target. Conversely, if the positional relationship indicates that the actual light spot coincides with the center of the calibration target, it indicates that the actual installation angle of the selected channel matches the desired installation angle, and thus there is no need to move the moving component 2. Instead, the center offset angle of the selected channel is directly recorded as [0, 0].

In Step S502: determining the vertical offset angle and horizontal offset angle of the channel to be calibrated based on the deflection angles of the moving component 2 in the vertical and horizontal directions. Specifically, the controller 3 obtains the deflection angles of the moving component 2 in the vertical and horizontal directions, which correspond to the vertical offset angle and horizontal offset angle of the channel to be calibrated.

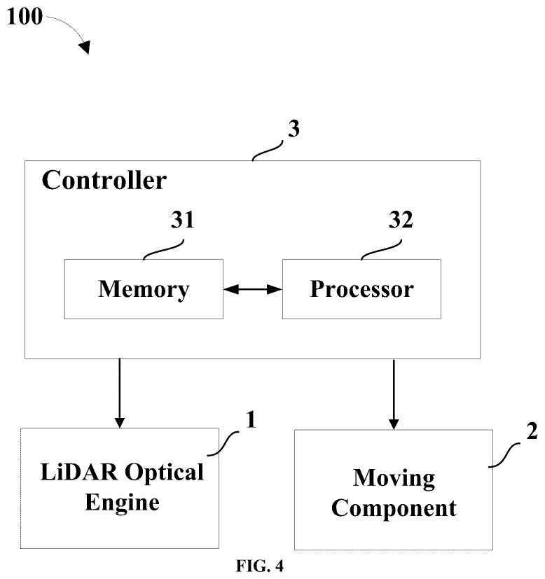

Referring to FIG. 3, a sub-flowchart of the calibration method for LiDAR channel angle error in accordance with the second embodiment is illustrated. In the second embodiment, when the positional relationship is such that the detection center of the LiDAR optical engine 1 is aligned with the center of the calibration target, Step S50 specifically includes Steps S503-S505.

In Step S503: measuring a first vertical offset length and a first horizontal offset length of the actual light spot relative to the reference light spot of each channel to be calibrated in the image. Specifically, the controller 3 measures the first horizontal offset length and first vertical offset length of the actual light spot relative to the reference light spot for each channel based on the image. It is understandable that the first horizontal offset length and first vertical offset length are in pixel units.

In Step S504: converting the first horizontal offset length and the first vertical offset length into a second horizontal offset length and a second vertical offset length in the spatial domain, representing the actual position of the real spot relative to the reference spot. It is understandable that the second horizontal offset length and the second vertical offset length are spatial length units. It should be noted that this application can convert the offset length of the real spot relative to the reference spot from pixel units to actual spatial length units by two methods. One method is by printing scales on the calibration target panel and using these scales. The other method is by calculating the specific size of a single pixel projected onto the calibration target 200. In other words, any method capable of converting the offset length of the real spot relative to the reference spot from pixel units to actual spatial length units is acceptable, and the conversion methods are not limited herein.

In Step S505: determining the vertical offset angle and the horizontal offset angle of the channel to be calibrated based on the second horizontal offset length and the second vertical offset length. Specifically, combine the second horizontal offset length and the second vertical offset length with the spatial distance between the LiDAR optical engine 1 and the calibration target 200 to calculate the horizontal offset angle offset_{yaw} and the vertical offset angle offset_{pitch} for each channel. The calculation methods for the horizontal offset angle offset_{yaw} and the vertical offset angle offset_{pitch} can be as follows, for example, assume that the vertical offset length and the spatial distance between the LiDAR optical engine 1 and the calibration target 200 is N, and after measurement, the second horizontal offset length is obtainedLen_{yaw}, and the vertical offset length is obtained as Len_{pitch}, then the second horizontal offset angle can be calculated asoffset_{yaw}=arctan (Len_{yaw}/N) and the second vertical offset angle can be calculated asoffset_{pitch}=arctan (Len_{pitch}/N). Of course, there can be other calculation methods for the horizontal offset angles and the vertical offset angles. The calculation methods for these two offset angles are not limited here. In this embodiment, the spatial distance N between the LiDAR optical engine 1 and the calibration target 200 can be configured based on actual needs. Given that, different LiDAR optical engine designs should use different distances, and the spatial distance N between the LiDAR optical engine 1 and the calibration target 200 can be obtained in any way, such as directly through the laser ranging function of the LiDAR optical engine 1. The spatial distance N between the LiDAR optical engine 1 and the calibration target 200, and the calculation method for the spatial distance N are not limited herein.

In Step S60: calibrating the channels to be calibrated based on the vertical offset angles and the horizontal offset angles of the channels to be calibrated. Specifically, the controller 3 determines the central offset angle [θ_{pitch}+offset_{pitch}, θ_{yaw}+offset_{yaw}] of the channel to be calibrated based on the vertical offset angle offset_{pitch} and horizontal offset angle offset_{yaw} of the channel to be calibrated, and then calibrates the channel based on the central offset angle. For example, assume that the desired installation angle of the channel to be calibrated is [2, 2], and both the vertical offset angle and the horizontal offset angle of the actual installation angle of the channel relative to the desired installation angle are 1, then the central offset angle of the channel to be calibrated is [2+1, 2 +1], that is [3, 3]. In this embodiment, the controller 3 writes the central offset angle [θ_{pitch}+offset_{pitch}, θ_{yaw}+offset_{yaw}] into a calibration table. It is understandable that after applying the above calibration method to all channels, the calibration table records the central offset angles of all channels, with each channel corresponding to a unique central offset angle.

The calibration method for LiDAR channel angle errors, as described above, can be executed in two ways. The first method: by manipulating the moving component 2 to ensure that the real spot precisely aligns with the center of the calibration target. Then, utilizing the horizontal and vertical deflection angles of the moving component 2, one can derive the vertical and horizontal offset angles that represent the deviation of the actual installation angle of the channel to be calibrated from the desired installation angle. The second method: Alternatively, by obtaining calibration target images of multiple channels, measuring the vertical offset length and the horizontal offset length betFirst, capture calibration target images for multiple channels. Subsequently, using these images, measure the vertical and horizontal offset lengths between the spots corresponding to the actual and desired installation angles of each channel. By integrating these measured lengths with the actual control distance between the LiDAR optical engine 1 and the calibration target 200, the vertical and horizontal offset angles for each channel's actual installation angle relative to the desired installation angle can be computed. Following the determination of these vertical and horizontal offset angles for each channel, calibration of each channel within the LiDAR optical engine is performed. This calibration process significantly enhances the detection accuracy of the LiDAR optical engine 1.

The disclosure further provides a controller 3 including a memory 31 and a processor 32. The memory 31 is configured to store computer programs, and the processor 32 is configured to execute the computer programs to implement a calibration method for angle errors of LiDAR channels. In this embodiment, the processor 32 may, in some embodiments, be a Central Processing Unit (CPU) 32, a microcontroller 3, a microprocessor 32, or other data processing chips, for running mobile calibration program instructions stored in the memory 31.

The memory 31 comprises at least one type of readable storage medium, which includes flash memory, a hard disk, a multimedia card, a card-type memory (e.g., SD or DX memory, etc.), magnetic storage, magnetic disks, optical disks, and the like. In some embodiments, the memory 31 may be an internal storage unit of a computer device, such as the hard disk of the computer device. In other embodiments, the memory 31 may also be a storage device of an external computer device, such as a plug-in hard disk equipped on a computer device, a Smart Media Card (SMC), a Secure Digital (SD) card, a Flash Card, and the like. Furthermore, the memory 31 may include both an internal storage unit of a computer device and an external storage device. The memory 31 can not only be used to store application software and various data installed on the computer device, such as code for implementing mobile intelligent processing, but also can be used to temporarily store data that has been output or will be output.

Referring again to FIG. 4, the disclosure further provides a calibration device 100 for angle errors of LiDAR channels. The calibration device 100 is arranged opposite to a calibration target 200 and comprises a LiDAR optical engine 1, a moving component 2, a fixed frame 4, and a controller 3. The LiDAR optical engine 1 includes multiple channels. The moving component 2 is configured to drive the LiDAR optical engine 1 to tilt vertically and/or rotate horizontally relative to the calibration target 200. The controller 3 is electrically connected to the LiDAR optical engine 1, the moving component 2, and an image acquisition device 300. The controller 3 is configured to control the LiDAR optical engine 1 to select and illuminate channels, to control the moving component 2 to move and thereby drive the LiDAR optical engine 1 to move relative to the calibration target 200, and to control the image acquisition device 300 to acquire a calibration target image of the channel to be calibrated and to calculate and analyze the calibration target image to obtain the center offset angle of the channel to be calibrated. In this embodiment, the calibration device 100 and the calibration target 200 are designed as an integral unit to ensure that after the LiDAR optical engine 1 is fixed to the fixed frame 4, the detection center of the LiDAR optical engine 1 is aligned with the center of the calibration target.

Referring again to FIG. 5, the disclosure further provides a calibration system 1000 for angle errors of LiDAR channels, including a calibration device 100, a calibration target 200, and an image acquisition device 300. The image acquisition device 300 is independently arranged relative to the calibration target 200 and the calibration device 100, and faces to the calibration target 200. The shooting range of the image acquisition device 300 covers an end face of the calibration target 200 close to the calibration device 100. The image acquisition device 300 is electrically connected to the controller 3. In this embodiment, the image acquisition device 300 is a camera, and the controller 3 controls the camera to acquire an image of the current calibration target 200 in the form of a photograph. Preferably, the image acquisition device 300 is wirelessly connected to the controller 3. In some feasible embodiments, the image acquisition device 300 may also be wired to the controller 3, and the connection mode between the image acquisition device 300 and the controller 3 is not limited herein. It should be noted that the sizes of the calibration target 200 and the calibration device 100, as well as the driving mode of the calibration device 100 and the LiDAR optical engine 1, can be set according to actual needs and are not limited herein.

Obviously, those skilled in the art can make various modifications and variations to the disclosure without departing from the spirit and scope thereof. Thus, if such modifications and variations of the disclosure fall within the scope of the claims and their equivalents, the disclosure is also intended to include these modifications and variations.

The above-enumerated examples are merely preferred embodiments of the disclosure and cannot be used to limit the scope of the claims of the disclosure. Therefore, equivalent variations made according to the claims of the disclosure still fall within the scope covered by the disclosure.

1. A calibration method for LiDAR channel angular error, being applied to a calibration device to calibrate channels of a LiDAR optical engine; wherein the calibration device faces a calibration target, and comprises a controller, and a moving component, the LiDAR optical engine is installed on the moving component, the LiDAR optical engine and the moving component are electrically connected to the controller, the controller is configured to control the moving component to deflect in a vertical direction and/or in a horizontal direction to drive the LiDAR optical engine to deflect relative to the calibration target, and the calibration method for LiDAR channel angular error comprises:
controlling the moving component to move in order to make a detection center of the LiDAR optical engine align with a center of the calibration target;
selecting one or more channels to be calibrated;
according to a positional relationship between the LiDAR optical engine and the calibration target, controlling the channels to be calibrated to project onto the calibration target in a predetermined direction to obtain one or more corresponding spot centers, wherein the positional relationship includes that each channel to be calibrated is aligned with the center of the calibration target, or the detection center of the LiDAR optical engine is aligned the center of the calibration target;
acquiring an image of the calibration target to obtain real spots and reference spots of the channels to be calibrated, wherein the real spots are spots projected by the channels to be calibrated onto the calibration target, and the reference spots are predetermined in the calibration target, when the positional relationship is that each channel to be calibrated is aligned with the center of the calibration target, the reference spots correspond to the center of the calibration target; when the detection center of the LiDAR optical engine is aligned with the center of the calibration target, the reference spots correspond to centers of the channels to be calibrated, and the image is acquired by an image acquisition device;
determining vertical offset angles and horizontal offset angles of the channels to be calibrated according to a positional relationship between the real spots and the reference spots of the channels to be calibrated obtained;
calibrating the channels to be calibrated according to the vertical offset angles and the horizontal offset angles of the channels to be calibrated.

2. The calibration method according to claim 1, wherein when the positional relationship is that each channel to be calibrated is aligned with the center of the calibration target, controlling, according to the positional relationship between the LiDAR optical engine and the calibration target, the channels to be calibrated to project onto the calibration target in the predetermined direction to obtain one or more corresponding spot centers comprises:
controlling the moving component to move so that each channel to be calibrated is aligned with the center of the calibration target in sequence; and
activating the channel to be calibrated that currently is aligned with the center of the calibration target.

3. The calibration method according to claim 2, wherein when the positional relationship is that each channel to be calibrated is aligned with the center of the calibration target, determining the vertical offset angles and the horizontal offset angles of the channels to be calibrated according to the positional relationship between the real spots and the reference spots of the channels to be calibrated obtained comprises:
according to a positional relationship between the real spots of the channels to be calibrated and the center of the calibration target, controlling the moving component to deflect in the vertical direction and/or in the horizontal direction until the real spots coincide with the center of the calibration target;
determining the vertical offset angles and the horizontal offset angles of the channels to be calibrated based on deflection angles of the moving component in the vertical direction and in the horizontal direction.

4. The calibration method according to claim 3, wherein, when the positional relationship is that each channel to be calibrated is aligned with the center of the calibration target, according to the positional relationship between the real spots of the channels to be calibrated and the center of the calibration target, controlling, the moving component to deflect in the vertical direction and/or in the horizontal direction until the real spots coincide with the center of the calibration target comprises:
if the real spots deviate from the center of the calibration target, controlling the moving component to deflect in the vertical direction so that the real spots and the center of the calibration target are on the same horizontal line; and
controlling the moving component to deflect in the horizontal direction so that the real spots completely coincide with the center of the calibration target.

5. The calibration method according to claim 1, wherein when the positional relationship is that the detection center of the LiDAR optical engine is aligned with the center of the calibration target, controlling, according to the positional relationship between the LiDAR optical engine and the calibration target, the channels to be calibrated to project onto the calibration target in the predetermined direction to obtain one or more corresponding spot centers comprises:
activating one or more channels to be calibrated in sequence or simultaneously.

6. The calibration method according to claim 5, wherein, when the positional relationship is that the detection center of the LiDAR optical engine is aligned with the center of the calibration target, according to the positional relationship between the real spots and the reference spots of the channels to be calibrated obtained, determining the vertical offset angles and the horizontal offset angles of the channels to be calibrated comprises:
measuring first vertical offset lengths and first horizontal offset lengths of the real spots of each channel to be calibrated relative to the reference spots in the image;
converting the first horizontal offset lengths and the first vertical offset lengths into actual second horizontal offset lengths and second vertical offset lengths of the real spots relative to the reference spots in space; and
determining the vertical offset angles and the horizontal offset angles of the channels to be calibrated based on the second horizontal offset lengths and the second vertical offset lengths.

7. The calibration method according to claim 6, wherein, when the positional relationship is that the detection center of the LiDAR optical engine is aligned with the center of the calibration target, determining the vertical offset angles and the horizontal offset angles of the channels to be calibrated according to the horizontal offset lengths and the vertical offset lengths comprises:
combining the second horizontal offset lengths with a spatial distance between the LiDAR optical engine and the calibration target to calculate horizontal offset angles of each channel; and
combining the second vertical offset lengths with the spatial distance between the LiDAR optical engine and the calibration target to calculate vertical offset angles of the channels to be calibrated.

8. The calibration method according to claim 1, wherein calibrating the channels to be calibrated according to the vertical offset angles and the horizontal offset angles of the channels to be calibrated specifically comprises:
determining center offset angles of the channels to be calibrated according to the vertical offset angles and the horizontal offset angles of the channels to be calibrated; and
calibrating the channels to be calibrated according to the center offset angles of the channels to be calibrated.

9. A calibration device for LiDAR channel angular error, configured to calibrate each channel of a LiDAR optical engine, the calibration device facing a calibration target, and comprise:
a moving component used for driving the LiDAR optical engine to deflect relative to the calibration target in a vertical direction and/or in a horizontal direction; and
a controller, comprising:
a memory, configured to store computer programs; and
a processor, configured to execute the computer programs to perform a calibration method for LiDAR channel angular error, the calibration method for LiDAR channel angular error comprising:
controlling the moving component to move in order to make a detection center of the LiDAR optical engine align with a center of the calibration target;
selecting one or more channels to be calibrated;
according to a positional relationship between the LiDAR optical engine and the calibration target, controlling the channels to be calibrated to project onto the calibration target in a predetermined direction to obtain one or more corresponding spot centers, wherein the positional relationship includes that each channel to be calibrated is aligned with the center of the calibration target, or the detection center of the LiDAR optical engine is aligned the center of the calibration target;
acquiring an image of the calibration target to obtain real spots and reference spots of the channels to be calibrated, wherein the real spots are spots projected by the channels to be calibrated onto the calibration target, and the reference spots are predetermined in the calibration target, when the positional relationship is that each channel to be calibrated is aligned with the center of the calibration target, the reference spots correspond to the center of the calibration target; when the detection center of the LiDAR optical engine is aligned with the center of the calibration target, the reference spots correspond to centers of the channels to be calibrated, and the image is acquired by an image acquisition device;
determining vertical offset angles and horizontal offset angles of the channels to be calibrated according to a positional relationship between the real spots and the reference spots of the channels to be calibrated obtained; and
calibrating the channels to be calibrated based on the vertical offset angles and the horizontal offset angles of the channels to be calibrated.

10. The calibration device according to claim 9, wherein when the positional relationship is that each channel to be calibrated is aligned with the center of the calibration target, controlling, according to the positional relationship between the LiDAR optical engine and the calibration target, the channels to be calibrated to project onto the calibration target in the predetermined direction to obtain one or more corresponding spot centers comprises:
controlling the moving component to move so that each channel to be calibrated is aligned with the center of the calibration target in sequence; and
activating the channel to be calibrated that currently is aligned with the center of the calibration target.

11. The calibration device according to claim 10, wherein when the positional relationship is that each channel to be calibrated is aligned with the center of the calibration target, determining the vertical offset angles and the horizontal offset angles of the channels to be calibrated according to the positional relationship between the real spots and the reference spots of the channels to be calibrated obtained comprises:
according to a positional relationship between the real spots of the channels to be calibrated and the center of the calibration target, controlling the moving component to deflect in the vertical direction and/or in the horizontal direction until the real spots coincide with the center of the calibration target; and
deriving the vertical offset angles and the horizontal offset angles of the channels to be calibrated according to angles of deflection of the moving component in the vertical direction and in the horizontal direction.

12. The calibration device according to claim 11, wherein, when the positional relationship is that each channel to be calibrated is aligned with the center of the calibration target, according to the positional relationship between the real spots of the channels to be calibrated and the center of the calibration target, controlling the moving component to deflect in the vertical direction and/or in the horizontal direction until the real spots coincide with the center of the calibration target comprises:
if the real spots deviate from the center of the calibration target, controlling the moving component to deflect in the vertical direction so that the real spots and the center of the calibration target are on the same horizontal line; and
controlling the moving component to deflect in the horizontal direction so that the real spots completely coincide with the center of the calibration target.

13. The calibration device according to claim 9, wherein when the positional relationship is that the detection center of the LiDAR optical engine is aligned with the center of the calibration target, controlling, according to the positional relationship between the LiDAR optical engine and the calibration target, the channels to be calibrated to project onto the calibration target in the predetermined direction to obtain one or more corresponding spot centers comprises:
activating one or more channels to be calibrated in sequence or simultaneously.

14. The calibration device according to claim 13, wherein, when the positional relationship is that the detection center of the LiDAR optical engine is aligned with the center of the calibration target, determining the vertical offset angles and the horizontal offset angles of the channels to be calibrated according to the positional relationship between the real spots and the reference spots of the channels to be calibrated obtained comprises:
measuring first vertical offset lengths and first horizontal offset lengths of the real spots of each channel to be calibrated relative to the reference spots in the image;
converting the first horizontal offset lengths and the first vertical offset lengths into actual second horizontal offset lengths and second vertical offset lengths of the real spots relative to the reference spots in space; and
determining the vertical offset angles and the horizontal offset angles of the channels to be calibrated according to the second horizontal offset lengths and the second vertical offset lengths.

15. The calibration device according to claim 6, wherein, when the positional relationship is that the detection center of the LiDAR optical engine is aligned with the center of the calibration target, determining the vertical offset angles and the horizontal offset angles of the channels to be calibrated according to the horizontal offset lengths and the vertical offset lengths comprises:
combining the second horizontal offset lengths with a spatial distance between the LiDAR optical engine and the calibration target to calculate horizontal offset angles of each channel; and
combining the second vertical offset lengths with the spatial distance between the LiDAR optical engine and the calibration target to calculate vertical offset angles of the channels to be calibrated.

16. The calibration device according to claim 1, wherein calibrating the channels to be calibrated according to the vertical offset angles and the horizontal offset angles of the channels to be calibrated specifically comprises:
determining center offset angles of the channels to be calibrated according to the vertical offset angles and the horizontal offset angles of the channels to be calibrated; and
calibrating the channels to be calibrated according to the center offset angles of the channels to be calibrated.

17. A calibration system for LiDAR channel angular error, comprising:
a calibration target;
an image acquisition device; and
a calibration device, for LiDAR channel angular error, configured to calibrate each channel of a LiDAR optical engine, the calibration device facing a calibration target; and comprises:
a moving component, configured to drive the LiDAR optical engine to deflect relative to the calibration target in a vertical direction and/or in a horizontal direction; and
a controller, comprising:
a memory, configured to store computer programs; and
a processor, configured to execute the computer programs to perform a calibration method for LiDAR channel angular error, the calibration method for LiDAR channel angular error comprising:
controlling the moving component to move in order to make a detection center of the LiDAR optical engine align with a center of the calibration target;
selecting one or more channels to be calibrated;
according to a positional relationship between the LiDAR optical engine and the calibration target, controlling the channels to be calibrated to project onto the calibration target in a predetermined direction to obtain one or more corresponding spot centers, wherein the positional relationship includes that each channel to be calibrated is aligned with the center of the calibration target, or the detection center of the LiDAR optical engine is aligned the center of the calibration target;
acquiring an image of the calibration target to obtain real spots and reference spots of the channels to be calibrated, wherein the real spots are spots projected by the channels to be calibrated onto the calibration target, and the reference spots are predetermined in the calibration target, when the positional relationship is that each channel to be calibrated is aligned with the center of the calibration target, the reference spots correspond to the center of the calibration target; when the detection center of the LiDAR optical engine is aligned with the center of the calibration target, the reference spots correspond to centers of the channels to be calibrated, and the image is acquired by an image acquisition device;
determining vertical offset angles and horizontal offset angles of the channels to be calibrated according to a positional relationship between the real spots and the reference spots of the channels to be calibrated obtained;
calibrating the channels to be calibrated according to the vertical offset angles and the horizontal offset angles of the channels to be calibrated.

18. The calibration system according to claim 17, wherein when the positional relationship is that each channel to be calibrated is aligned with the center of the calibration target, controlling, according to the positional relationship between the LiDAR optical engine and the calibration target, the channels to be calibrated to project onto the calibration target in the predetermined direction to obtain one or more corresponding spot centers comprises:
controlling the moving component to move so that each channel to be calibrated is aligned with the center of the calibration target in sequence; and
activating the channel to be calibrated that currently is aligned with the center of the calibration target.

19. The calibration system according to claim 18, wherein when the positional relationship is that each channel to be calibrated is aligned with the center of the calibration target, determining the vertical offset angles and the horizontal offset angles of the channels to be calibrated according to the positional relationship between the real spots and the reference spots of the channels to be calibrated obtained comprises:
according to a positional relationship between the real spots of the channels to be calibrated and the center of the calibration target, controlling the moving component to deflect in the vertical direction and/or in the horizontal direction until the real spots coincide with the center of the calibration target;
deriving the vertical offset angles and the horizontal offset angles of the channels to be calibrated according to angles of deflection of the moving component in the vertical direction and in the horizontal direction.

20. The calibration system according to claim 3, wherein, when the positional relationship is that each channel to be calibrated is aligned with the center of the calibration target, according to the positional relationship between the real spots of the channels to be calibrated and the center of the calibration target, controlling, the moving component to deflect in the vertical direction and/or in the horizontal direction until the real spots coincide with the center of the calibration target comprises:
if the real spots deviate from the center of the calibration target, controlling the moving component to deflect in the vertical direction so that the real spots and the center of the calibration target are on the same horizontal line; and
controlling the moving component to deflect in the horizontal direction so that the real spots completely coincide with the center of the calibration target.
